(19) United States
(12) Patent Application Publication
(10) Pub. No.: US 2019/0369625 A1
(43) Pub. Date: Dec. 5, 2019

(54) AUTOMATIC CHARGING SYSTEM FOR ROBOT AND METHOD THEREOF

(71) Applicant: Quanta Computer Inc., Taoyuan City (TW)

(72) Inventors: Chun-Ting CHEN, Taoyuan City (TW); Yang-Sheng WANG, Taoyuan City (TW); Yu-Ching CHEN, Taoyuan City (TW); Tao-Chih HSU, Taoyuan City (TW)

(21) Appl. No.: 16/126,255

(22) Filed: Sep. 10, 2018

(30) Foreign Application Priority Data
May 29, 2018 (TW) 107118275

(51) Int. Cl. G05D 1/02

(52) U.S. Cl. CPC G05D 1/0217; G05D 2201/0203; G05D 1/0225

(57) ABSTRACT

An automatic charging method for robots is provided, including the following steps: a control terminal generates a plurality of current tasks that correspond to different task areas according to a task map; a plurality of robots receive the current tasks, and the first battery level required for the current task is calculated; each of the robots ascertains a plurality of positions that correspond to a plurality of charging stations, and the second battery level required to arrive at each of the charging stations is calculated according to the current position of each of the robots and the locations of the charging stations; and each of the robots determines whether to charge its battery based on the current battery level, the first battery level, the second battery level, and the low battery threshold.

### CROSS REFERENCE TO RELATED APPLICATIONS

This application claims priority of Taiwan Patent Application No. 107118275, filed on May 29, 2018, the entirety of which is incorporated by reference herein.

### BACKGROUND OF THE INVENTION

### Field of the Invention

The present invention relates to an automatic charging system for robots and a method thereof, and more particularly to an automatic charging system for robots and a method thereof, wherein the method involves calculating in advance the remaining power in the robot to determine whether the robot requires a charge.

### Description of the Related Art

With the advancement of science and technology, robots have been widely adopted for a variety of uses. However, when there are multiple robots performing tasks at the same time, it is important to arrange a charging strategy for these multiple robots. In general, when a robot is almost out of power, it moves directly to the nearest charging station for charging, but when more than one robot is out of power at the same time, conflicts may occur. Alternatively, although a robot may be relatively close to a first charging station, and far from the next task area, the distance to the next task area must be taken into consideration to avoid wasting power. Therefore, how to efficiently arrange the charging position of a robot is currently a problem that needs to be solved.

### BRIEF SUMMARY OF INVENTION

An embodiment of the present invention provides an automatic charging method for robots, including the following steps: a control terminal generates a plurality of current tasks corresponding to different task areas according to a task map; a plurality of robots receive the current tasks, and the first battery level required for the current task is calculated; each of the robots ascertains a plurality of positions that correspond to a plurality of charging stations, and the second battery level needed to arrive at each of the charging stations is calculated based on the current position of each of the robots and the locations of the charging stations; and each robot determines whether to charge its battery based on the current battery level, the first battery level, the second battery level, and the low battery threshold.

Another embodiment of the present invention provides an automatic charging system for robots, including a control terminal and a plurality of robots. The control terminal includes a first storage unit and a first processing unit. The first storage unit stores a task map. The first processing unit generates a plurality of current tasks corresponding to a different task area according to the task map. Each robot includes a positioning unit, a second storage unit, and a second processing unit. The positioning unit ascertains the current position of each robot. The second storage unit stores the current task received from the control terminal and a plurality of positions that respectively correspond to a plurality of charging stations. The second processing unit calculates the first battery level required for the current task, calculates the second battery level needed to arrive at each of the charging stations according to the current position of each robot and the locations of the charging stations, and determines whether to charge its battery based on the current battery level, the first battery level, the second battery level, and the low battery threshold.

### BRIEF DESCRIPTION OF DRAWINGS

The invention can be more fully understood by reading the subsequent detailed description and examples with references made to the accompanying drawings, wherein:

FIG. 1 is a system architecture diagram of an automatic charging system for robots in accordance with an embodiment of the present invention.

FIGS. 2A-2E are a flow chart of an automatic charging method for robots in accordance with an embodiment of the present invention.

### DETAILED DESCRIPTION OF INVENTION

Further areas to which the present automatic robot charging systems and methods thereof can be applied will become apparent from the detailed description provided herein. It should be understood that the detailed description and specific examples, while indicating exemplary embodiments of the automatic robot charging systems and methods thereof, are intended for the purposes of illustration only and are not intended to limit the scope of the invention.

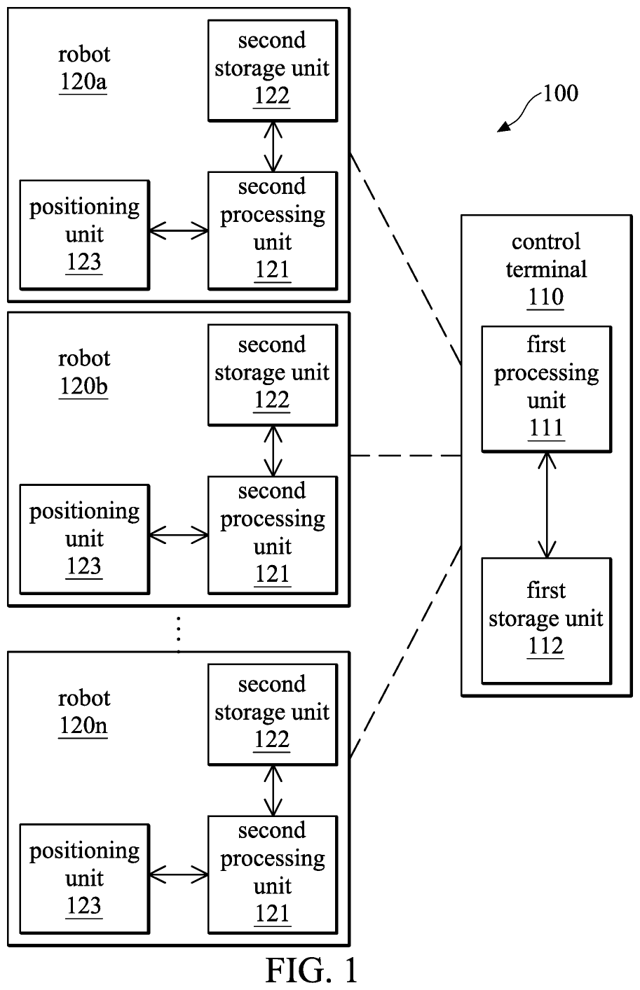

FIG. 1 is a system architecture diagram of an automatic charging system for robots in accordance with an embodiment of the present invention. The automatic charging system 100 includes a control terminal 110 and a plurality of robots 120a-120n. The control terminal 110 can be implemented in an electronic device, such as a server, a desktop computer, a notebook, a tablet computer, or a smart phone, and includes at least a first processing unit 111 and a first storage unit 112. The first processing unit 111 can be implemented in a variety of ways, for example, in a dedicated hardware circuit or general hardware, such as a single processor, a multiprocessor with parallel processing capability, a graphics processor, or another processor with computational capabilities. When the first processing unit 111 executes code or software, it performs the functions described below. The first storage unit 112 is configured to store at least one task map, task related information generated according to the task map, current positions of the robots 120a-120n, positions of a plurality of charging stations, and task related parameters transmitted by the robots 120a-120n, etc., adapted for the first processing unit 111 to access. The first storage unit 112 can be a non-volatile storage device, such as a hard disk, a flash memory, or a ROM. The control terminal 110 further includes a communication interface (not shown), such as a local area network (LAN) communication module, a wireless local area network communication module (WLAN) or a Bluetooth communication module. The communication module communicates with each of the robots 120a-120n to send and receive various signals and data.

The robots 120a-120n can be robots having a cleaning function, and each of the robots 120a-120n includes at least a second processing unit 121, a second storage unit 122, and a positioning unit 123. Similarly, the second processing unit 121 can be implemented in a variety of ways, for example, in a dedicated hardware circuit or a general hardware, such as a single processor, a multiprocessor with parallel processing capability, a graphics processor, or other processor with computational capabilities. When the second processing unit 121 executes code or software, it provides the functions described below. The second storage unit 122 can be a non-volatile storage device, such as the hard disk, the flash memory, or the ROM, for storing task-related information received from the control terminal 110, the positions of the plurality of charging stations, power consumption information related to the size of the task area (such as the area that can be cleaned when consuming 1% of the battery power) and power consumption information related to the moving distance (such as the distance that can robot be moved when consuming 1% of battery power). The positioning unit 123 is used to locate the positions of the robots 120a-120n on the task map for the second processing unit 121 to perform the calculation related to the task. The second processing unit 121 can further calculate task-related parameters according to the current position of each of the robots 120a-120n, the position of each charging stations, the area of the current task, the area of the next task, and a starting point of the next task, etc., and determines whether to charge the battery of each robot based on the calculated task-related parameters.

According to an embodiment of the present invention, when any one of the robots 120a-120n receives the current task assigned by the control terminal 110, the second processing unit 121 of the robot then performs the calculation according to the size of the area corresponding to the current task to ascertain the first battery level required for completing the current task and the second battery level required for the robot to move from the current position to each of the charging stations. Then, the second processing unit 121 recalculates the first battery level and the second battery level at every predetermined time interval (i.e. 5 seconds), and subtracts the current battery level from the first battery level and the second battery level to ascertain the first predicted remaining battery level. Moreover, the second processing unit 121 further determines whether the first predicted remaining battery is greater than a low-power threshold, thereby to determine whether the robot can successfully complete the current task and then move to any one of the charging stations for charging. When any one of the first predicted remaining batteries corresponding to each of the charging stations is greater than the low-power threshold, which indicates that the robot is able to successfully complete the current task and move to one of the charging stations for charging, and the second processing unit 121 continues to drive the robot to perform the current task. However, when each of the plurality of first predicted remaining batteries is less than or equal to the low-power threshold, the second processing unit 121 determines that the robot cannot complete the current task or may not be able to move to the charging station after completing the task, and then the second processing unit 121 drives the robot to move to a suitable charging station for charging according to an order of the first predicted remaining batteries. For example, Table 1 shows an example of the first predicted remaining batteries corresponding to different charging stations S1˜S3 and different robots according to an embodiment of the present invention.

TABLE 1

| | S1 | S2 | S3 |
|---|---|---|---|
| 120a | 5% | 15% | 25% |
| 120b | 7% | 12% | 15% |
| 120c | 17% | 25% | 15% |

In this embodiment, the low-power threshold is set to 15%. As shown in Table 1, although the first predicted remaining batteries of the robot 120a for the charging stations S1 and S2 are less than or equal to the low-power threshold, the first predicted remaining battery of the robot 120a for the charging station S3 is still greater than the low-power threshold, so the second processing unit 121 of the robot 120a continues to perform the task and will not output a charging request to the control terminal 110. Similarly, the first predicted remaining batteries of the robot 120c for the charging station S2 is greater than the low-power threshold, so the robot 120c continues to perform the task without outputting the charging request to the control terminal 110. On the other hand, after the calculation, the first predicted remaining batteries of the robot 120b for the charging stations S1˜S3 are all less than or equal to the low-power threshold, so the second processing unit 121 outputs the charging request to the control terminal 110 according to the order of the first predicted remaining batteries of the robot 120b. In the embodiment of the present invention, the second processing unit 121 will choose the charging station that corresponds to the largest first predicted remaining battery as a target for charging. For example, since the first predicted remaining battery corresponding to the charging station S3 is the largest, the second processing unit 121 will select the charging station S3 as the target and outputs the charging request corresponding to the charging station S3 to the control terminal 110. The first processing unit 111 of the control terminal 110 replies a confirmation signal to the robot 120b in response to the charging request. After the second processing unit 121 of the robot 120b receives the confirmation signal, the second processing unit 121 drives the robot 120b to move to the charging station S3 for charging.

TABLE 2

| | S1 | S2 | S3 |
|---|---|---|---|
| 120a | 5% | 14% | 15% |
| 120b | 7% | 12% | 14% |
| 120c | 17% | 25% | 15% |

According to another embodiment of the present invention, when the first processing unit 111 of the control terminal 110 receives charging requests corresponding to the same charging station at the same time, the first processing unit 111 further decides to assign the usage priority of the charging station to robots according to the order of the first predicted remaining batteries of the different robots. For example, as shown in Table 2, the first predicted remaining batteries of the robots 120a and 120b are all less than or equal to the low-power threshold, and the largest first predicted remaining battery of the robot 120a and 120b both correspond to the charging station S3. Therefore, both the second processing units 121 of the robots 120a and 120b output the charging request corresponding to the charging station S3 to the control terminal 110. When the control terminal 110 receives more than one charging requests corresponding to the charging station S3 at the same time, since the first predicted remaining battery corresponding to the robot 120b is lower than the first predicted remaining battery corresponding to the robot 120a, which means that the robot 120b needs to be charged preferentially, the second processing unit 121 sends a confirmation signal to the robot 120b and outputs a rejection signal to the robot 120a. After the robot 120a receives the rejection signal, the second processing unit 121 of the robot 120a takes the charging station that corresponds to the second-largest of the first predicted remaining batteries as the target for charging, and outputs the corresponding charging request. In other words, in this embodiment, after receiving the rejection signal, the second processing unit 121 of the robot 120a outputs the charging request corresponding to the charging station S2 to the control terminal 110. At this time, since the first processing unit 111 of the control terminal 110 does not receive a request for charging corresponding to other robots (according to Table 2), the confirmation signal will be output to the robot 120a so that the robot 120a can be charged at the charging station S2.

It should be noted that when any one of the robots 120a-120n receives the confirmation signal corresponding to any charging station, the first processor 111 of the control terminal 110 will ignore other first predicted remaining batteries corresponding to other robots so as to avoid interference with other robots. For example, as shown in Table 2, if the robot 120a outputs the charging request corresponding to the charging station S2, although the first predicted remaining battery of the robot 120a is greater than the first predicted remaining battery of the robot 120b (i.e., 14%>12%), since the robot 120b has already received the confirmation signal corresponding to the charging station S3, the first processing unit 111 will ignore the first predicted remaining battery corresponding to the robot 120b and send the confirmation signal to the robot 120a.

According to another embodiment of the present invention, in addition to the current task, the robots 120a-120n may further consider the next task and calculate the power required for the next task in advance, so that the robot can be charged before performing the next task. For example, the second processing unit 121 calculates the third battery level required to complete the next task after completing the current task but before moving to any of the charging stations. Then, the second processing unit 121 determines whether to charge at the charging station before performing the next task according to the current battery level and the third battery level. For example, the second processing unit 121 first ascertains the second difference between the current battery level and the third battery level and sets the second difference as a second predicted remaining battery. Then, the second processing unit 121 determines whether the second predicted remaining battery is greater than the low-power threshold. When the second predicted remaining battery is greater than the low-power threshold, which means the robot should be able to complete the next task, then the robot moves from the current position to the starting point of the next task and starts the next task. Since the power required to complete the next task is greater than the power needed for the robot to move to the starting point of the next task from the current position (after completing the current task), the second predicted remaining battery only considers the power for the next task. In a preferred embodiment, the second processing unit 121 may further consider the power required for the robot to move from the current position to the start position of the next task if more accurate remaining battery is required.

Conversely, when the second predicted remaining battery is less than or equal to the low-power threshold, the second processing unit 121 further calculates a fourth battery level for moving to each of the charging stations and then to the starting point of the next task based on the current position of the robot, the position of each of the charging stations and the starting point of the next task. When the task area corresponding to the current task is far from the task area corresponding to the next task, if the robot only selects the charging station closest to the task area corresponding to the current task for charging, unnecessary power may be generated. Therefore, the power required to move from the charging station to the starting point of the next task is additionally considered. Then, the second processing unit 121 further selects the charging station that corresponds to the lowest of the fourth battery levels as the target for charging, and outputs the charging request to the control terminal 110. Finally, the first processing unit 111 of the control terminal 110 determines to output the confirmation signal to which charging station according to the number of the received charging requests. The method for determining whether the charging station corresponding to the confirmation signal is the same as the description above, it is not described to simplify the content of the description.

In addition, according to another embodiment of the present invention, during charging one of the robots, when another robot needs to be charged at this charging station (such as the current battery level of the robot is not enough to move to other charging stations), then the first processing unit 111 of the control terminal 110 will cause the charged robot to be charged to a first threshold (such as 35% of the battery level), notify the charged robot to leave the charging station, and then send the confirmation signal to the robot waiting to be charged. For example, when a robot is being charged, and there is another robot needs to use the charging station, the first processing unit 111 might waits until the charged robot reaches 35% of the power level to send a leaving signal to notify the charged robot to leave, and then send the confirmation signal to the robot that is waiting for moving to the charging station for charging.

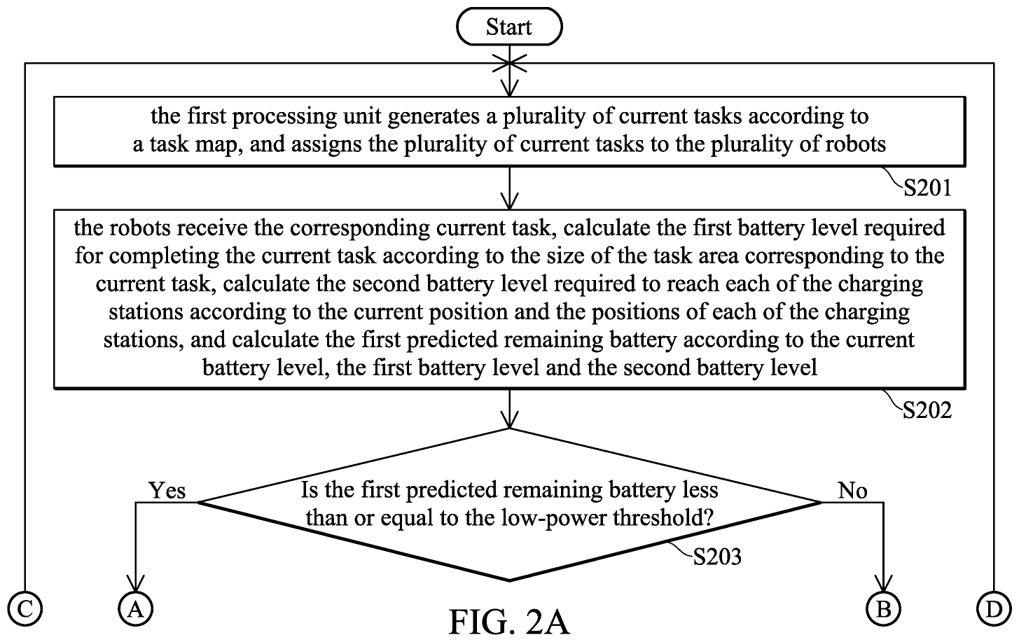

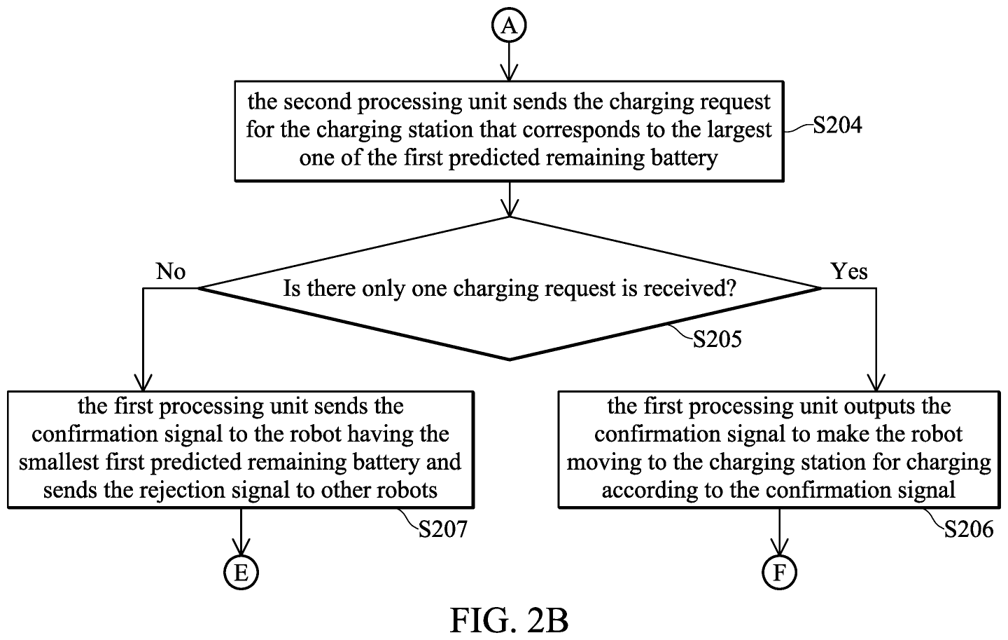

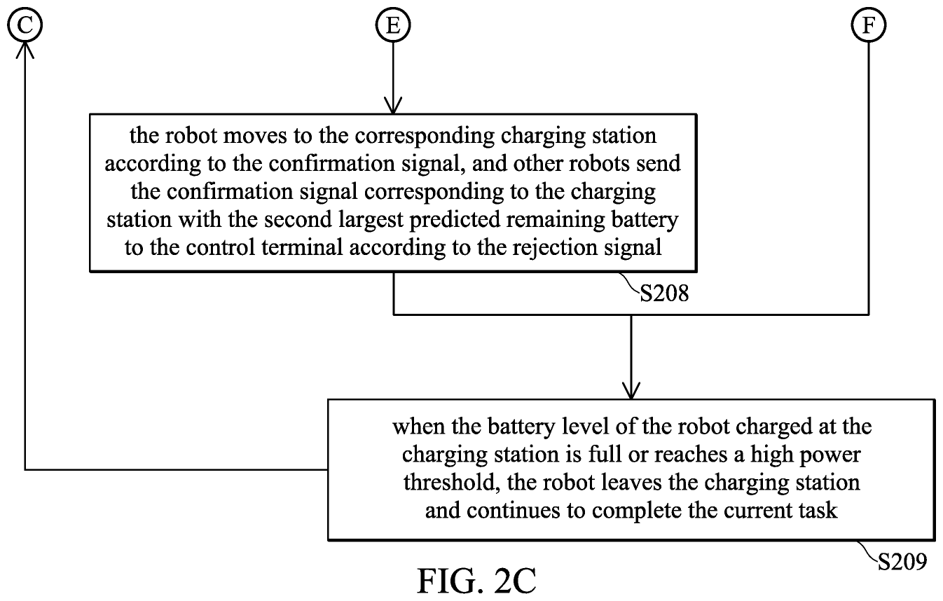

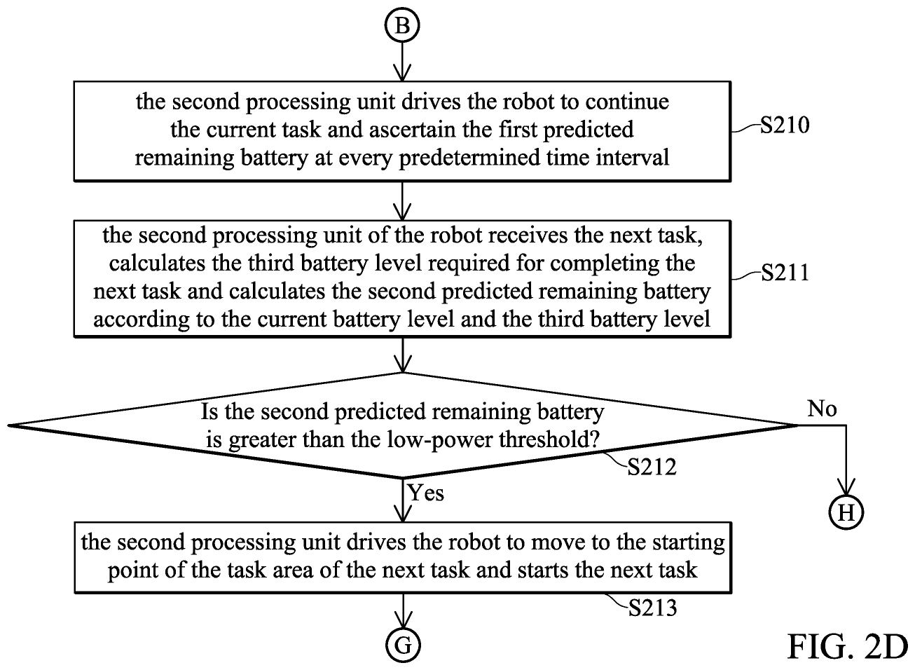

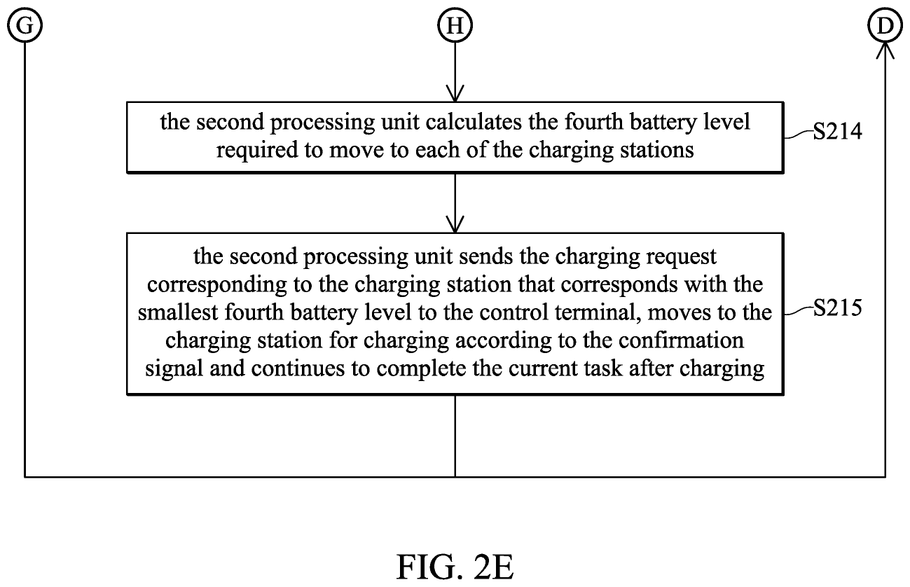

FIGS. 2A-2E are a flow chart of an automatic charging method for robots in accordance with an embodiment of the present invention. At step S201, the first processing unit 111 of the control terminal 110 generates a plurality of current tasks corresponding to the plurality of different task areas according to a task map stored in the first storage unit 112, and assigns the plurality of current tasks to the plurality of robots 120a-120n. At step S202, the robots 120a-120n receive the corresponding current task from the control terminal 110, calculate the first battery level required for completing the current task according to the size of the task area corresponding to the current task and calculate the second battery level required to reach each of the charging stations according to the current position and the positions of each of the charging stations. Finally, the second processing unit 121 of each of the robots calculates the first difference between the current battery level and the first battery level and the second battery level, and sets the first difference as the first predicted remaining battery. At step S203, each second processing unit 121 determines whether the first predicted remaining battery is less than or equal to the low-power threshold. When the first predicted remaining batteries corresponding to all charging stations are less than or equal to the low-power threshold, which means the robot cannot complete the current task, the method proceeds to step S204, the second processing unit 121 sends the charging request for the charging station that corresponds to the largest one of the first predicted remaining battery. At step S205, after the control terminal 110 receives the charging request, the first processing unit 111 further determines whether there is only one charging request is received. If the first processing unit 111 only receives one charging request, the method proceeds to step S206, the first processing unit 111 outputs the confirmation signal to make the robot moving to the charging station for charging according to the confirmation signal.

Otherwise, if the first processing unit receives the charging requests from the plurality of robots corresponding to the same charging station at the same time, the method proceeds to step S207, the first processing unit 111 sends the confirmation signal to the robot having the lowest first predicted remaining battery, i.e., the robot that needs to be charged most, and sends the rejection signal to other robots. At step S208, the robot moves to the corresponding charging station according to the confirmation signal, and other robots send the confirmation signal corresponding to the charging station with the second largest predicted remaining battery to the control terminal 110 according to the rejection signal. Next, the method proceeds to step S209, when the battery level of the robot charged at the charging station is full or reaches a high power threshold, the robot leaves the charging station and continues to complete the current task.

In addition, at step S203, when any one of the first predicted remaining batteries is greater than the low-power threshold, which means the robot can complete the current task and move to the corresponding charging station for charging, and then the method proceeds to step S210, the second processing unit 121 drives the robot to continue the current task and ascertain the first predicted remaining battery at every predetermined time interval. After completing the current task, the method proceeds to step S211, and the second processing unit 121 of the robot receives the next task and calculates the third battery level required for completing the next task. At step S212, the second processing unit 121 further calculates the second difference between the current battery level and the third battery level as the second predicted remaining battery, and determines whether the second predicted remaining battery is greater than the low-power threshold. When any one of the second predicted remaining batteries is greater than the low-power threshold, the method proceeds to step S213, the second processing unit 121 drives the robot to move to the starting point of the task area of the next task and starts the next task.

In contrast, at step S212, when all of the second predicted remaining batteries are less than or equal to the low-power threshold, the method proceeds to step S214, the second processing unit 121 calculates the fourth battery level required to move to each of the charging stations and then to the starting point according to the current position, the positions of each of the charging stations, and the starting point of the next task. At step S215, the second processing unit 121 sends the charging request corresponding to the charging station that corresponds with the lowest fourth battery level to the control terminal 110, and moves to the charging station for charging according to the confirmation signal. Then, when the battery level of the charged robot is full or reaches the high power threshold, the robot leaves the charging station and continues to complete the next task.

The methods, or certain aspects or portions thereof, may take the form of a program code (i.e., executable instructions) embodied in tangible media, such as floppy diskettes, CD-ROMS, hard drives, or any other machine-readable storage medium, wherein, when the program code is loaded into and executed by a machine, such as a computer, the machine thereby becomes an apparatus for practicing the methods. The methods may also be embodied in the form of a program code transmitted over some transmission medium, such as electrical wiring or cabling, through fiber optics, or via any other form of transmission, wherein, when the program code is received and loaded into and executed by a machine, such as a computer, the machine becomes an apparatus for practicing the disclosed methods. When implemented on a general-purpose processor, the program code combines with the processor to provide a unique apparatus that operates analogously to application specific logic circuits.

As described above, according to the embodiments of the automatic charging system for robots and the method thereof, by calculating and comparing the power required for each robot to move to each charging station in advance, when the control terminal receives more than one charging request from the robots, the control terminal can immediately assign the usage priority of the charging station to a robot according to the predicted level of power remaining in each robot. In addition, the present invention further considers the power required to move to the charging station and the starting point of the next task to avoid unnecessarily wasting power.

It will be apparent to those skilled in the art that various modifications and variations can be made to the structure disclosed without departing from the scope or spirit of the invention. In view of the foregoing, it is intended that the present invention covers modifications and variations of this invention, provided they fall within the scope of the following claims and their equivalents.

What is claimed is:

1. An automatic charging method for robots, comprising:
using a control terminal to generate a plurality of current tasks, each of which respectively corresponds to a different task area according to a task map;
a plurality of robots receive the current tasks, and a first battery level required for the current tasks is calculated;
each of the robots ascertains a plurality of positions corresponding to a plurality of charging stations, and a second battery level required to arrive at each of the charging stations is calculated according to a current position of each of the robots and the locations of the charging stations; and
each of the robots determines whether to charge its battery based on a current battery level, the first battery level, the second battery level, and a low battery threshold.

2. The automatic charging method for robots as claimed in claim 1, further comprising:
calculating a first difference between the current battery level and the first battery level plus the second battery level as a first predicted remaining battery level for each charging station; and
determining whether each first predicted remaining battery is less than or equal to the low battery threshold;
wherein when any of the plurality of first predicted remaining batteries is greater than the low battery threshold, the robot continuously performs the current task, and determines whether to charge the battery according to the plurality of first predicted remaining batteries at every predetermined time interval.

3. The automatic charging method for robots as claimed in claim 2, wherein when all of the first predicted remaining batteries of any one of the robots are less than the low battery threshold, the robot stops performing the current task and sends a charging request corresponding to the largest one of the plurality of first predicted remaining batteries to the control terminal according to the order of the plurality of first predicted remaining batteries.

4. The automatic charging method for robots as claimed in claim 3, further comprising:
the control terminal determines whether the plurality of charging requests from the plurality of robots corresponding to the same charging station are received;
wherein when the control terminal only receives one charging request from a robot, the control terminal outputs a confirmation signal to the robot, and the robot moves to the charging station that corresponds to the charging request according to the confirmation request for charging; and
wherein when the control terminal receives the plurality of charging requests from the plurality of robots, the control terminal only outputs one confirmation request to the robot with the lowest first predicted remaining battery, and outputs a rejection signal to the other robots.

5. The automatic charging method for robots as claimed in claim 4, wherein the robot further sends the charging request for the charging station that corresponds to the second-largest of the first differences after receiving the rejection signal.

6. The automatic charging method for robots as claimed in claim 2, wherein when the robot completes the current task, the robot further calculates a third battery level required for the next task, and determines whether to charge the battery according to the current battery level, the third battery level, and the low battery threshold.

7. An automatic charging system for robots, comprising:
a control terminal, comprising:
a first storage unit, storing a task map; and
a first processing unit, generating a plurality of current tasks corresponding to different task areas according to the task map; and
a plurality of robots, wherein each robot comprises:
a positioning unit, which ascertains the current position of each robot;
a second storage unit, which stores the current task received from the control terminal and a plurality of positions that respectively correspond to a plurality of charging stations; and
a second processing unit, calculating the first battery level required for the current task, calculating the second battery level required to arrive at each of the charging stations according to the current position of each of the robots and the locations of the charging stations, and determining whether to charge its battery based on the current battery level, the first battery level, the second battery level, and the low battery threshold.

8. The automatic charging system for robots as claimed in claim 7, wherein the second processing unit further calculates the first difference between the current battery level and the first battery level plus the second battery level as a first predicted remaining battery for each charging station, and determines whether each first predicted remaining battery is less than or equal to the low battery threshold, and wherein when any of the plurality of first predicted remaining batteries is greater than the low battery threshold, the second processing unit continuously performs the current task, and determines whether to charge the battery according to the plurality of first predicted remaining batteries at every predetermined time interval.

9. The automatic charging system for robots as claimed in claim 8, wherein when all of the first predicted remaining batteries of any one of the robots are less than the low battery threshold, the second processing unit stops performing the current task and sends a charging request that corresponds to the largest one of the plurality of first predicted remaining batteries to the first processing unit according to the order of the plurality of first predicted remaining batteries.

10. The automatic charging system for robots as claimed in claim 9, wherein the first processing unit further determines whether the plurality of charging requests from the plurality of robots for the same charging station are received, wherein when the control terminal only receives one charging request from the robot, the control terminal outputs a confirmation signal to the robot, and the robot moves to the charging station that corresponds to the charging request according to the confirmation request for charging, and when the control terminal receives the plurality of charging requests from the plurality of robots, the control terminal only outputs one confirmation request to the robot with the lowest first predicted remaining battery, and outputs a rejection signal to the other robots.

11. The automatic charging system for robots as claimed in claim 10, wherein the second processing unit further sends the charging request for the charging station that corresponds to the second-largest of the first differences after receiving the rejection signal.

12. The automatic charging system for robots as claimed in claim 8, wherein when the robot completes the current task, the second processing unit further calculates the third battery level required for the next task, and determines whether to charge the battery according to the current battery level, the third battery level, and the low battery threshold.
